(19) United States
(12) Patent Application Publication
(10) Pub. No.: US 2004/0229600 A1
(43) Pub. Date: Nov. 18, 2004

(54) Method and apparatus for call screening and management in a wireless communication device

(75) Inventors: William N. Saez, Pantation, FL (US); Yong. C. Lee, Plantation, FL (US); Jyh-Han Lin, Coral Springs, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/436,787

(22) Filed: May 13, 2003

(51) Int. Cl. H04M 3/42

(52) U.S. Cl. 455/417; 455/550.1

(57) ABSTRACT

A wireless communication device with local call screening services receives a call via a wireless receiver. The call comprises a caller identification. A memory for storing information corresponding to the caller identification and a plurality of rules, the plurality of rules comprising instructions for call screening is made available to a processor. The processor implements a call manager operable to provide an automatic call screening of the communication in accordance to the plurality of rules as applied to the information corresponding to the caller identification. Manual call screening is supported with multiple options for disposition of the call, including the ability to store messages locally. Methods for implementing the manual and automatic call screening are also described.

### FIELD OF THE INVENTION

This invention relates in general to wireless communication devices, and more specifically to a method and apparatus for call screening and incoming call management in a wireless communication device.

### BACKGROUND OF THE INVENTION

Methods exist in cellular and landline telephone systems for an incoming call to a wireless communication device to be directed to a network-based voice message device or for such a call to be forwarded to another number when there is no answer. For instance, when a call is made to a cellular telephone and the cellular telephone is not powered on, the network infrastructure may be programmed to forward the call to a voice message application so the caller may leave a message. When the user of the cellular telephone has the unit on and is in a coverage area, the user can use the cellular telephone to retrieve the message. When a cellular device is on and in a coverage area, the user may be able to see the phone number or name of a caller associated with the phone number through caller ID or the like however this is very limited information about the caller. A user of a landline phone with an answering machine may choose to not answer a call until after a caller has begun to leave a message. Once the identity or the nature of the call becomes clear, the user may choose to take the call by answering the phone.

However, the user of a wireless communication device does not have this basic call screening capability, nor is there a way for a caller to leave a message in a manner so the message can be retrieved using the wireless communication device unless access to the network infrastructure is available. Clearly, a need exists for improved methods and apparatus for call screening and management in a wireless communication device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a block diagram of a communications system showing sources of incoming communications;

FIG. 2 depicts, in a simplified and representative form, a block diagram of a wireless communication device with local call screening in accordance with the current invention;

FIG. 3 is a flow chart depicting a method for local call disposition; and

FIG. 4 is a flow chart depicting additional details of the FIG. 3 method for local call disposition.

### DETAILED DESCRIPTION OF PREFERRED EMBODIMENT

In overview, the present disclosure concerns wireless communication devices that provide call screening and management capability supported on the wireless communication device without intervention from a network infrastructure. The user of the wireless communication device may or may not be directly involved in the call management process. More particularly various inventive concepts and principles embodied in methods and apparatus for call screening and management of incoming calls are discussed. The wireless communication devices of particular interest are those using Code Division Multiple Access (CDMA), Universal Mobile Telephone Service (UMTS), Time Division Multiple Access (TDMA), Global System for Mobile Communications (GSM), Second Generation GSM (2G), and Third Generation (3G) networks and the like or evolutions thereof, however applicability to virtually all hand held wireless devices capable of supporting voice and data calls is anticipated.

As further discussed below various inventive principles and combinations thereof are advantageously employed to essentially move call screening and message management and disposition functions to a wireless communication device. This gives the user of such a device flexibility in handling incoming calls over what is currently available, either through manual screening or by invocation of user-programmed rules for automatically managing calls, provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

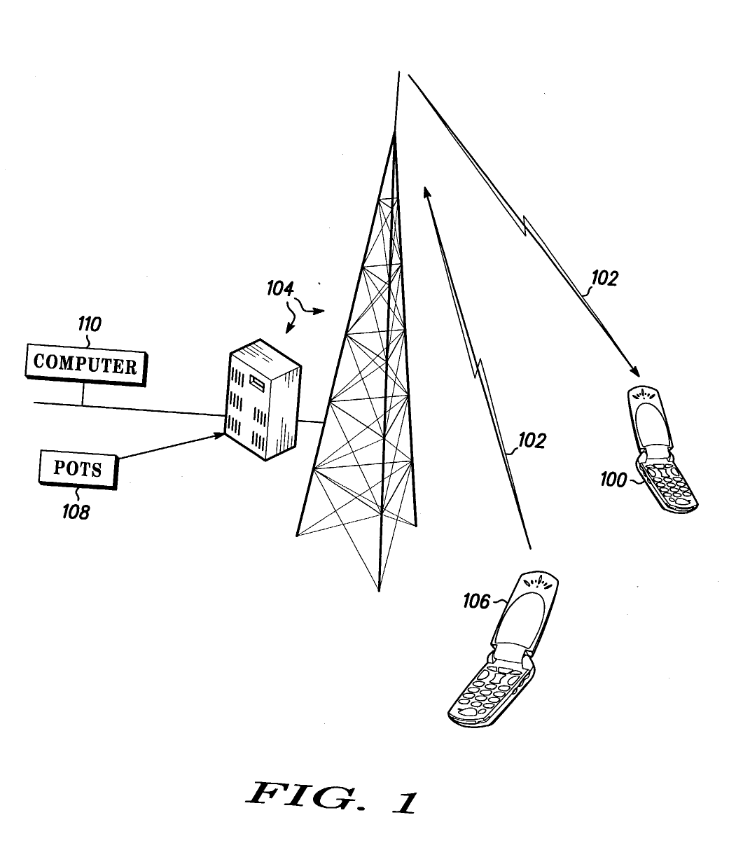

Referring to FIG. 1 a simplified and representative block diagram of a communications system suitable for explaining the environment for the present invention and showing sources of incoming communications will be discussed and described. A wireless communication device 100 receives communications over a communications channel 102 via a network infrastructure 104. The communications may be any of several types, including a standard cellular voice call, a text message such as a short message service (SMS) message, a dispatch communication or a direct mobile-to-mobile communication. The wireless communication device can be a cellular handset, messaging device, wireless personal digital assistant or the like and may receive such incoming calls from a number of sources. For example, the source of the incoming communication may be another wireless communication device 106, a plain old telephone system (POTS) 108 or a computer 110 attached via a network, such as the Internet, to the network infrastructure 104.

The wireless communication device 100 may be supplied with or subscribe to caller identification service suitable for indicating the source of the communications or call. Some wireless communication devices may be able to match or associate the telephone number in a caller identification message to a user name in an internal phone book that is stored in a local memory. The user of the wireless communication device 100, when convenient can look at the caller identification before deciding to take the call. If the user chooses not to answer the call, the network infrastructure 104, may be operable to take and store a voice message from the caller. If such a message is stored, the user of the wireless communication device 100 can usually retrieve such a message by contacting the network infrastructure 104 or voice mail service. Reliance on the network infrastructure 104 for call management does not take advantage of the power of the wireless communication device nor does it give the user of the wireless communication device the flexibility to manage communications effectively as wireless communication devices become more a part of everyday life.

The wireless communication device 100 described herein has new and inventive capabilities to manage and dispose of calls locally or internally based on a range of programmatically accessible data. The wireless communication device 100 is constructed to allow a caller to record a message that is stored locally in the wireless communication device 100 rather than on the network infrastructure. In addition, a user of the wireless communication device 100 is able to listen to the message as it is being recorded and choose to accept the call after the recording process has started, unlike network-based voice mail. In addition to the manual call screening just described; the wireless communication device 100 is also capable of automatic call screening. The user of the wireless communication device 100 can load or program rules for how incoming communications are handled based on information related to the identity of the caller or other status data for the caller, such as family, friend or business associate, or open commitments to the caller, and the like. Rules for incoming communication screening can also be based on the status of the user, for example, the wireless communication device can evaluate the user's calendar appointments and determine if he or she is in a meeting at the time a communication arrives. Other information available to the wireless communication device can be used in evaluating how to manage an incoming communication, such as when the user may be fishing, based on a geographic location from a Global Positioning Receiver.

The equipment comprising the network infrastructure 104 such as switches, radio access networks, routers and the like is well known and available from vendors such as Motorola, Inc and others. The equipment comprising plain old telephone sets is well known and available from various companies. Such equipment is used to make a phone call to the wireless communication device 100. The equipment comprising the computer 110 with access to a network is readily available from companies such as Dell and Hewlett Packard and may use any of a number of software applications to send a communication to the wireless communication device 100, such as Microsoft's Internet Explorer web browser in conjunction with a messaging web site, such as Skytel.

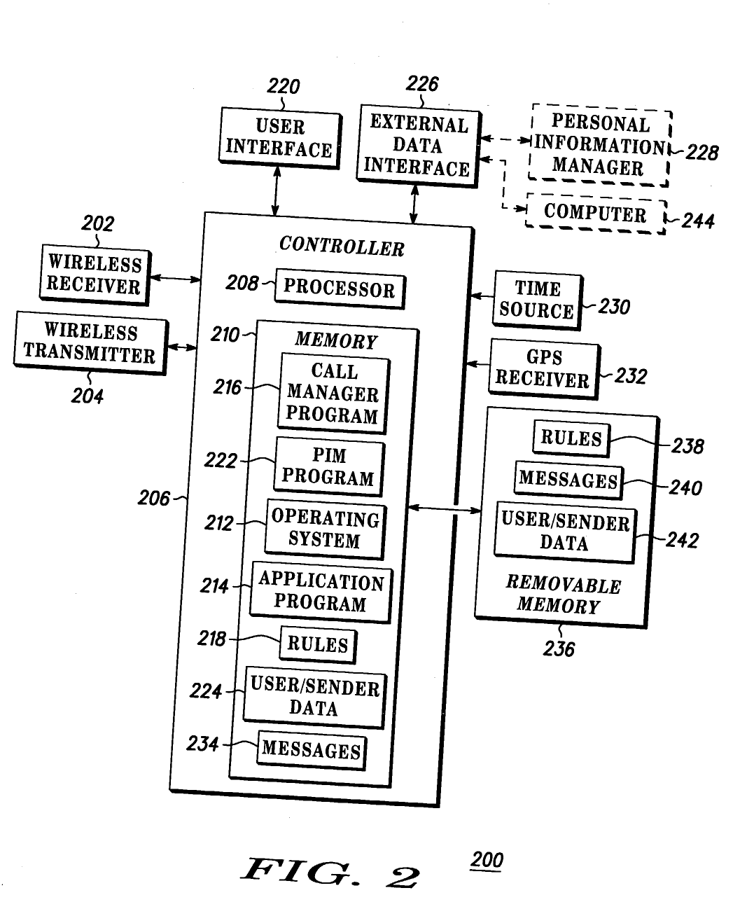

Referring to FIG. 2, a block diagram of a wireless communication device 200 with local call screening will be discussed and described. This device is suitable for use and similar to the wireless device 100 of FIG. 1. A wireless receiver 202 and wireless transmitter 204 for receiving incoming communications and sending outgoing communications are coupled to a controller 206. The controller 206 comprises a processor 208 and a memory 210. The memory 210 is used for storage and retrieval of the operating system instructions 212 and other application programs 214 as and when executed by the processor 208. Of particular interest is an application program, the call manager program 216. The call manager program 216 is operable to analyze the conditions surrounding the incoming communication and apply rules 218, especially user-defined rules, for call screening or call management at the local level. The controller 206 is coupled to a user interface 220 for the display of information corresponding to the caller, particularly information beyond name and phone number, and for receiving operational instructions from the user of the wireless communication device 200, for example during the process of deciding how to dispose of an incoming communication or call.

Another available application in the wireless communication device 200 is a personal information manager 222 or PIM. The PIM 222 is a combination of and includes, such information as address book, appointment calendar, action item or to-do list, and the like. Sender or caller data and user data 224 are stored in the memory often under the control of the PIM 222 program. With the sender data and user data 224 available to the call manager program 216, a rich and varied set of data is available for application of and development of appropriate rules 218 to be applied to call screening and call management. An external data interface 226 is available for connecting to an external personal information manager 228, for example, a Palm Pilot to facilitate, for example, rules development or application and other data base management and maintenance activities.

Most wireless communication devices have a time source 230 or clock. This is typically an internal clock or a time reference supplied by the network infrastructure 104 for providing date and time information. When the call manager program 216 has access to date and time information via the time source 230 an additional level of call screening and call management functions can be added to the rules 218, as will be explained.

The wireless communication device 200 may have access to information regarding its own geographic location. This can be supplied by the network infrastructure 104, by any of a number of location technologies, for example, time difference of arrival or angle difference of arrival. It may also be supplied by an attached or integrated Global Positioning System (GPS) receiver 232. When the call manager program 216 has access to location information, such as from a GPS receiver 232 an additional level of call screening and call management functions can be added to the rules 218, as explained below.

The controller 206 is also capable of using the memory 210 to store a message 234 from a caller or sender. This is primarily a voice message, but any message capable of being monitored by the user while the message is being transferred to the wireless communication device 200 can be used in a manual call screening process.

The memory 210 may be supplemented by an external, removable memory 236. The removable memory 236 is useful mainly for information that may be useful to move from one wireless communication device to another, such as rules 238, messages, 240 and user/sender data 242. It is possible that additional information could be stored in the removable memory 236 for a given implementation. An example of such a removable memory 236 is a subscriber identity module, often called a SIM card, as used in GSM cellular phone systems.

The development of rules 218, especially those with complex conditions, may become difficult to accomplish on the wireless communication device 200 due to limitations in the user interface 220 such as screen size or keyboard layout. In such a case, a computer 244 coupled to the external data interface 226 may be used to develop a set of rules and then transfer them to the memory allocated for rules 218, 238. While in an ideal case a user would develop his or her own rules, in other situations this task may be handled by a corporate information technology department or other designated person.

In operation, the wireless communication device with local call screening operates in the following manner. A wireless communication device 200 with local call screening services uses the wireless receiver 202 for receiving a communication where the communication comprises a caller identification. The caller identification is typically the telephone number of the telephone 108 or cellular telephone 106 calling the wireless communication device 200. The wireless communication device 200 also comprises the memory 206 for storing information corresponding to the caller identification, such as caller or sender data 224. The memory 206 is also used to store a plurality of rules 218, where the plurality of rules 218 comprise instructions for call screening. A third element in the memory 206 is a program for implementing a call manager 216, where the processor 208 executes the call manager program 216 when an incoming communication is received.

The call manager 216 is operable to provide an automatic call screening of the communication in accordance to the plurality of rules as applied to the information corresponding to the caller identification. Manual call screening is distinguished from automatic call screening in that manual call screening requires that the user interact with the wireless communication device 200 as part of the call screening process. Automatic call screening is performed when the wireless communication device 200 operates under its own programming, in this case the call manager 216, to determine the disposition of a call without intervention from the user. For example, a call is received and the caller or sender data 224 is accessed to determine that the caller is always to be put through, being perhaps a family member, and the wireless communication device 200 rings or vibrates in a normal manner to alert the user. In another example, the caller identification matches a former stockbroker, now trying to win back business. The user has programmed a rule 218 that a message should be taken and stored in memory 234 for all calls from the former stockbroker. In another example, a former romantic interest has started calling repeatedly and the user has programmed a rule 218 that all these calls are to be terminated or ignored.

The plurality of rules are effectively a plurality of call screening actions where each of the plurality of call screening actions is executed when corresponding predetermined conditions are satisfied. The predetermined conditions may be one of a sender status, a user status, a wireless communication device status, and situation circumstances. The sender status may be a relationship of the caller or sender to the user, such as a family member or business associate. It could be a name, such as John Smith, known by the user to be someone for which an automatic call screening action is preferred or defined. The sender status may further comprise those senders for whom no specific information is available, that is, the set of all senders or callers for whom there is no information matching the caller identification or even calls with no caller identification. In the latter case, one of the rules 218 may be to terminate such a call or terminate after x rings, based on the assumption that the call is from a telemarketer. The user status relates to information pertaining to the user. This is discussed in more detail in the personal information manager 222 (PIM) discussion following. The wireless communication device 200 status relates to a characteristic of the phone itself. For example, if a battery level in the wireless communication device 200 is lower than a trigger level, non-essential calls may be forwarded to another number, allowing the user to conserve power for a higher priority call. If the wireless communication device 200 is equipped with either a time source or a location indicator, the situation circumstances may be provided by either or both to allow the user a particularly robust set of rules related to the physical location of the wireless communication device 200 or the time. For example, the user may create a rule 218 for the wireless communication device 200 not to accept calls between 6:30pm and 7:30pm. In another example, the user may create a rule 218 such that if the wireless communication device 200 is within a certain geographic area, for example a favorite fishing area, the wireless communication device will only take messages from senders or some class of senders.

The sender data and user data 224 may have more information, for example not only a name but additional information such as an appointment or an action item or other commitment that the user has with the sender. This information can be used to create more abstract rules, such as alerting the user with any call from someone the user has an appointment with in the next 48 hours.

Appointment information, such as discussed above, is often stored in a personal information manager 222, also known as a PIM. The implementation of a personal information manager in the wireless communication device 200 or the ability to attach to an external PIM 228 may extend the amount and type of information available to the user for creating rules for automatic call screening to a more robust or extensive data set. The PIM 222, 228 typically contains data related to both a number of senders and the user. As discussed above, the PIM 222, 228 may be an ideal place to store information about the sender for use in rules, such as work and family relationships, appointments and other commitments. The PIM 222, 228 may also store data about the user, as discussed above, such as appointments and other commitments used by the rules 218 to determine if predetermined conditions for call screening are met.

So far, only single condition rules have been discussed, but more complex rules 218 based on more than one condition are supported, for example, no calls from work associates on Saturday except the president.

Manual call screening, as opposed to automatic call screening, involves user participation in responding to a call. Many wireless communication devices offer the user the ability to observe a phone number of the caller or sender before deciding to either accept the call or wait for the network-based voice mail to give the caller an opportunity to leave a message. In some cases, the name of the user may be associated with the caller identification and displayed using an internal phone book. A novel element herein is more robust manual call screening with the addition of supplemental data for review and more choices for the disposition of the call. Locally stored information 224, 236, may be displayed on the user interface 220 when a call is received, such as an image associated with the sender or caller, an appointment with the sender, or a status of the sender, such as the buyer from company x′ are examples of such supplemental information. The image may be a portrait of the sender but may as well be a cartoon or other figure meaningful to the user.

The user interface 220 is operable to display and capture input from the user regarding additional choices for call disposition including ending the call, forwarding the call, and having the sender or caller leave a message locally on the wireless communication device 200. In the case where a message is left and stored locally, especially a voice message, the user has the option to listen to the message as it is being recorded and mute the audio but keep recording, accept the call and end recording, or listen to the message in its entirety as it is stored but not accept the call. When the wireless communication device 200 has a locally stored message the user does not need to be in a network coverage area to be able to listen to the message from the wireless communication device 200.

In an alternate embodiment, a call manager for handling calls in a wireless communication device 100 is comprised of a memory for storing both a plurality of rules for call management and information corresponding to a plurality of callers. The call manager further comprises a processor, coupled to the memory, operable to analyze an incoming call for information corresponding to one of the plurality of callers and apply a portion of the plurality of rules corresponding to one of the plurality of callers to handle a disposition of the incoming call.

The call manager may also comprise a time source, coupled to the processor, operable to provide a date or a time wherein the incoming call is handled according to a portion of the plurality of rules applicable at the current date or time. The call manager may also comprise a Global Positioning System to provide the location of the wireless communication device 100 to the processor, wherein the incoming call is handled according to a portion of the plurality of rules applicable to the location of the wireless communication device 100.

The call manager can further also comprise a user interface coupled to the processor for interacting with a user of the wireless communication device and wherein the disposition of the incoming call comprises one of ending the incoming call, storing a message from the caller, forwarding the incoming call, and notifying the user.

The equipment or entities included in the wireless communication device 200 are known and readily available. When these entities are modified or programmed in accordance with the principles and concepts discussed and disclosed herein they are suitable for and can be used advantageously for call management and screening on a local basis. The wireless receiver 202 and wireless transmitter 204 are available commercially in the form of chipsets from manufacturers such as Motorola, Inc., supplemented by other commercially available discrete components. Reference designs for the wireless communication device 200 are available from suppliers of the major components of such devices. The controller 206 is commercially available from manufacturers such as Motorola, Inc and may include digital signal processing elements as part of the processor 208 and memory 210. Onboard input/output ports are used to couple to the user interface 220 and to implement the external data interface 226 and interfaces for other peripheral devices 230, 232, 236. The user interface 220 is comprised mainly of a keypad and display, and both are readily available in the marketplace from a number of commercial suppliers. The time source 230 may be implemented in software in the controller 206 but may be a standalone chip from suppliers such as Dallas Semiconductor. The Global Positioning System (GPS) receiver is available as a chip from suppliers such as Motorola and Philips. The removable memory may be any of several types such as flash memory or a memory stick available from a number of commercial suppliers but one embodiment uses a subscriber identity module or SIM chip, available from smart card suppliers such as Gemplus and Schlumberger.

The programming of the call manager program 216 may be in a hardware specific run time language such as Advanced Risc Machine (ARM) assembler language or in higher level language such as C or Java. The programming of the functions and rules support for the call manager are easily within the capability of one with ordinary skill in the software arts.

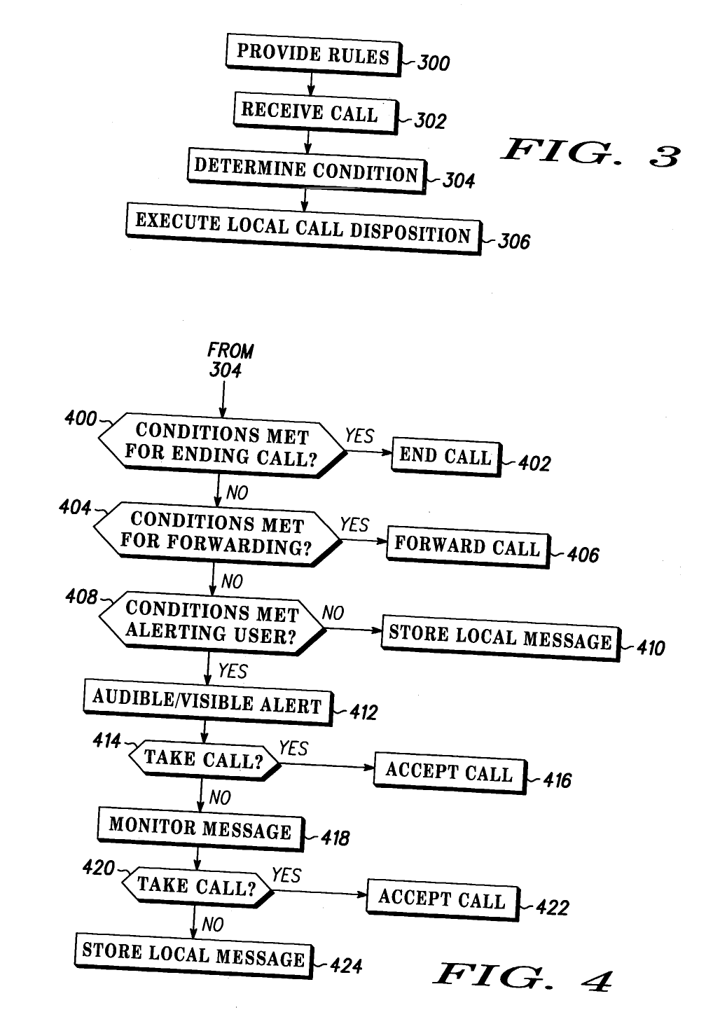

Referring to FIG. 3 a flow chart depicting a method for local call disposition will be discussed and described. A plurality of rules 300 comprising instructions for local call disposition is provided by either a user or a representative of the user. The rules may be entered via the wireless communication device 200, a user interface 220, or a computer 244 that is capable of downloading the rules to a memory accessible by the wireless communication device 200 such as internal memory 210 or external memory 236. An attachable personal information manager 228 may also serve as a device for both creating and storing the plurality of rules. The rules may be in the form of text statements following a prescribed format, such as human readable text or may be compiled for quicker execution and smaller size, such as Java bytecode. When a call is received 302, one or more conditions related to the call are evaluated to determine if the condition or conditions related to the call satisfy predetermined conditions specified in the plurality of rules. The predetermined conditions may apply to sender identity and status, user status, caller identification numbers for which data is not available in local memory 224 and calls with no accompanying caller identification. If a matching condition is determined 304, one or more of the plurality of rules whose predetermined conditions are met are used to execute one or more actions to handle the disposition of the call 306 on behalf of the user of the wireless communication device 200.

Specifically, the plurality of rules may correspond to a plurality of call screening actions where each of the plurality of call screening actions is executed when the predetermined conditions are satisfied. The predetermined conditions may comprise sender or caller status, user status, and situation circumstances. The situation circumstances may include time and date, as provided by an internal or network-based time source. Other situation circumstances such as location may be provided by an internal or network-based positioning system.

Referring to FIG. 4 a flow chart of a portion of the FIG. 3 method showing additional detail for local call disposition will be discussed and described. In an exemplary embodiment the following process may be followed in executing the local call disposition of 306.

Conditions corresponding to the call are tested at 400 for conditions matching predetermined conditions for ending the call. When a predetermined condition or conditions, such as the name of a former girlfriend, are met, the call is ended 402. Network infrastructure-based 104 voice mail may be operable to take a message in such a case.

If the test at 400 fails a further test at 404 is performed for conditions matching forwarding the call. When the predetermined conditions, such as the user is in a meeting but the caller is important are satisfied, the call may be forwarded to an assistant at 406. In the case of call forwarding, a new call can be dialed as in current 3-way calling using a predetermined number. Another embodiment could forward a control message to the network infrastructure 104 with instructions to forward the call to a predetermined number or to one embedded in the control message.

If the test at 404 fails a further test at 408 is performed for conditions matching alerting the user. Should the predetermined conditions not be met, the wireless communication device may be programmed to take a message on behalf of the user at 410. When the predetermined conditions, such as a call from the president of the company or the user's spouse, are met, the wireless communication device 200 may activate the user interface 220 to alert the user to a call matching his or her criteria at 412. The user is then able to evaluate the conditions corresponding to the call using his or her own criteria at 414 and decide to accept the call 416 or continue to 418. At 418, the user may monitor a message being left by the caller or sender and at 420 decide to accept the call 422 or continue to allow the wireless communication device 200 to take and store the message 424.

The processes and apparatus discussed above, and the inventive principles thereof are intended to and will alleviate problems caused by inadequacies in network-based voice mail and current local call screening and call management capabilities on wireless communication devices. Bringing a rich set of call screening and call management capabilities to the user of a wireless communication device will improve the user's ability to manage his or her time, take important calls and screen out those that can be deferred. This not only lowers the burden on network resources by moving some call management functions to the local wireless communication device but gives the user more flexibility to listen to messages stored locally rather than in the network infrastructure. Additional functionality such as selective call forwarding is offered to users of the wireless communication device 200.

The coupling of personal information manager or PIM data to incoming call management is another feature allowing complex rules to be created and executed for incoming call management. The use of PIM data, where callers may be categorized, not just named as in a current wireless communication device phone directory, increases the flexibility for call screening and management. General rules may be created for callers to be identified by their status as customers, family, coworkers, etc. This will greatly speed the rule creation process and allow for easier maintenance of such rules. The computing power and memory capacity of wireless communication devices are evolving rapidly. The ability to support the processes and apparatus described above are easily envisioned in near term devices.

Various embodiments of methods, systems, and apparatus for local call screening and call management in wireless communication devices have been discussed and described. It is expected that these embodiments or others in accordance with the present invention will have application to many classes of personal communication devices. The disclosure extends to the constituent elements or equipment comprising such devices and specifically the methods employed thereby and therein.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A wireless communication device with local call screening services comprising:
a wireless receiver for receiving a communication; comprising a caller identification;
a memory for storing:
information corresponding to the caller identification; and
a plurality of rules, the plurality of rules comprising instructions for call screening; and
a processor, coupled to the wireless receiver and the memory, suitable to implement:
a call manager operable to provide an automatic call screening of the communication in accordance to the plurality of rules as applied to the information corresponding to the caller identification.

2. The wireless communication device of claim 1 wherein the plurality of rules further comprise a plurality of call screening actions, each of the plurality of call screening actions executed when predetermined conditions are satisfied.

3. The wireless communication device of claim 2 wherein the predetermined conditions comprise one of a sender status, a user status, a wireless communication device status, and situation circumstances.

4. The wireless communication device of claim 3 further comprising:
one of a time source and a location indicator, each coupled to the processor; and
wherein the situation circumstances are provided by the one of the time source and the location indicator.

5. The wireless communications device of claim 4 wherein the location indicator is a Global Positioning System receiver.

6. The wireless communication device of claim 1 wherein the information corresponding to the caller identification comprises one of:
an image, an appointment with a sender, an action item, and a status of the sender.

7. The wireless communication device of claim 1 wherein the information corresponding to the caller identification comprises a name of the sender and an additional information.

8. The wireless communication device of claim 7 wherein the additional information comprises one of an image, an appointment, an action item, and a status of the sender.

9. The wireless communications device of claim 2 further comprising a personal information manager, coupled to the call manager, for managing a first data set corresponding to a sender, wherein the predetermined conditions further comprise a portion of the first data set.

10. The wireless communications device of claim 9:
wherein the personal information manager is further operable to manage a second data set corresponding to a user of the wireless communication device; and
wherein the predetermined conditions further comprise a portion of the second data set.

11. The wireless communication device of claim 9 further comprising:
a user interface, coupled and responsive to the call manager, for displaying a portion of the first data set and for providing a manual call screening, wherein the portion of the first data set comprises one of an action item, an appointment, and an image.

12. The wireless communications device of claim 1 wherein the communication further includes a message from the sender and the call manager is further operable to store the message in the memory.

13. The wireless communication device of claim 12 wherein the call manager is further operable to provide a manual call screening wherein a user of the wireless communication device monitors the message from the sender before responding to the communication.

14. The wireless communications device of claim 1 wherein the memory further comprises a removable memory.

15. A call manager for handling calls in a wireless communication device, the call manager comprising:
a memory for storing:
a plurality of rules for call management; and
information corresponding to a plurality of callers; and
a processor, coupled to the memory, operable to analyze an incoming call for information corresponding to one of the plurality of callers and apply a portion of the plurality of rules corresponding to the one of the plurality of callers to handle a disposition of the incoming call.

16. The call manager of claim 15 further comprising:
a user interface coupled to the processor for interacting with a user of the wireless communication device; and
wherein the disposition of the incoming call comprises one of ending the incoming call, storing a message from the caller, forwarding the incoming call, and notifying the user.

17. The call manager of claim 15 further comprising:
a Global Positioning System receiver coupled to the processor operable to provide a location of the wireless communication device to the processor, wherein the incoming call is handled according to a portion of the plurality of rules applicable to the location of the wireless communication device.

18. The call manager of claim 15 further comprising:
a time source, coupled to the processor, operable to provide one of a date and a time wherein the incoming call is handled according to a portion of the plurality of rules applicable at the one of the date and the time.

19. The call manager of claim 15 wherein the processor is operable to store the plurality of rules and wherein the plurality of rules are created for the user and are provided from one of the user interface and an external device coupled to the processor.

20. A method for local call disposition in a wireless communication device comprising:
providing a plurality of rules comprising instructions for the local call disposition;
receiving a call;
determining a condition corresponding to the call; and
executing the local call disposition in accordance to the plurality of rules as applied to the condition corresponding to the call.

21. The method of claim 20 wherein the providing the plurality of rules further comprises:
providing a plurality of call screening actions, each of the plurality of call screening actions executed when predetermined conditions are satisfied;
wherein the predetermined conditions further comprise one of a sender status, a user status, and situation circumstances.

22. The method of claim 21 further comprising:
providing one of a time source and a location indicator, wherein the situation circumstances are provided by the one of the time source and the location indicator.

23. The method of claim 20 wherein the executing the local call disposition comprises one of:
ending the call;
taking a message from a caller;
forwarding the call; and
alerting a user of the wireless communication device and displaying an information corresponding to the call.

24. The method of claim 23 further comprising:
monitoring the message from the caller before the user responds to the call.
